(19) United States
(12) Patent Application Publication
(10) Pub. No.: US 2006/0019643 A1
(43) Pub. Date: Jan. 26, 2006

(54) Method of sending instruction to mobile phone by short message

(75) Inventors: Cheng-Shing Lai, Taipei Hsien (TW); Fu-Dong Wang, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/893,945

(22) Filed: Jul. 20, 2004

(51) Int. Cl. H04M 3/00; H04Q 7/20

(52) U.S. Cl. 455/419; 455/466

(57) ABSTRACT

The present invention discloses a method of sending instructions to a mobile phone by short message, which uses a short message service provided in mobile phones to send a short message attached with a control information or instruction therein, and enables a mobile phone at a receiving end to execute the attached control information or instruction sent from a transmitting device end and then be controlled by the transmitting device accordingly.

### BACKGROUND OF THE INVENTION

1. Field of the Invention

The present invention relates to a method of sending instructions to a mobile phone, more particularly to a method of sending instructions from one transmitting device to mobile phones at a receiving end through short messages, enabling the mobile phones to execute the control information or instruction attached in the short message and be controlled by the transmitting device.

2. Description of the Related Art

Since our life has entered into a new era with booming telecommunication technologies, mobile phones have brought a hot wave to the telecommunication industry in the recent years. In early nineties, there were only about 1,000 mobile telecommunication users in the world; and a decade after, there are over 3.5 hundred million users now. The statistical data of the International Telecommunication Union (ITU) forecasted that there would be 5 hundred million mobile telecommunication users by the end of 2003, which would be about half of the quantity of the traditional city phones (about 9.5 hundred millions) by that time. For a conservative estimate, the number of mobile phones will go far beyond the number of city phone users after 2005, and the mobile phone will become a mainstream of telecommunications. The cellular mobile phone telecommunication is a revolutionary change to the telephone technology, which is no longer a node-to-node call, but is a person-to-person telecommunication. In addition, since the mobile phone is light and handy, easy-to-carry, reasonably priced, and capable of roaming over the network, mobile telecommunication become less restricted by time and space, and everyone can use it anywhere anytime. Therefore, mobile phones become a necessity of our telecommunications.

As the development of mobile phones proceeds up to now, it evolves from the original medium for transmitting voices to the present device concurrently having the function of transmitting information. As to the types of the data transmission, the first-generation mobile phones generally use an analog specification for the transmission, and the content of transmission is primarily voices. Both confidentiality and transparency are not as good. The second-generation mobile phones generally use a digital specification for the transmission. After a voice is digitized and coded, the digital codes are transmitted in packets, which greatly enhances the confidentially. However, with the arrival of the network era, the demand for digital webs and wireless webs is increasing, and mobile phones have been specified as an important integrated, controlled communication unit among independent products in the information appliance area. Till then, the demand for the data transmission of mobile phones greatly increases, and only the transmission and processing of the voice were taken into consideration at the early stage of establishing the second-generation mobile phone specification, but the data volume of pure digitized voice is not large. The transmission rate of 9.6 Kbps is sufficient for the second-generation mobile phones, but if it needs to process data containing images and files, then the transmission rate of the second-generation mobile phone is insufficient. Thus, the specifications for the second and half generation and the third generation were developed to cope with the huge data volume in this network era. The present transmission rate of the 2.5th generation specification reaches 115 kbps. With the great improvement on transmission rate, the requirements of transmission rate for static screens can be fulfilled, and the objectives of the wireless web under the established 2.5th generation transmission specification can be achieved finally. The establishment of the third-generation specification further raises the transmission rate to 2.4 Mbps, so that transmission of dynamic images can be implemented on a mobile phone. After the era of 3G has arrived, we can even watch televisions and movies or conduct person-to-person video conferencing through a mobile phone. The era of 3G will make our life more convenient, the access of information more timely, and the integration of communication, information, and network more closely. The structure of a mobile phone is divided into hardware and software, and the hardware is further divided into a baseband module, an intermediate frequency module, a radio frequency module and other components. The radio frequency module comprises a power amplifier (PA), a transmission receiver and a synthesizer; the intermediate frequency has an AD or DA signal converter; and the baseband module comprises a digital signal processor (DSP), a microcontroller (MCU) and a memory. Other components include a housing, a liquid crystal display (LCD), a printed circuit board (PCB), an antenna, a keypad, a speaker, a microphone, a subscriber identity module (SIM) and a battery.

In the basic operation of a mobile phone, an antenna receives a signal; a radio frequency module receives and amplifies the signal; an analog/digital (A/D) converter converts an analog signal into a digital signal; and finally the DSP of the baseband module processes the digital signal. In general, a mobile phone usually comes with a short message service (SMS) function, but such short message does not have the control function. In other words, the present mobile phone is unable to use a short message to control another mobile phone. Therefore, if there is a design that allows a short message of a mobile phone can be used to control another mobile phone, so that the mobile phone receiving the short message can execute the corresponding control instruction, such design not only brings tremendous convenience to the extensive consumers, but also provides a great contribution to the telecommunication technology.

### SUMMARY OF THE INVENTION

With the previous profound introduction of the prior art, it is not difficult for us to see that if a mobile phone is not connected to another mobile phone with a cable, it is unable for a mobile phone to control another mobile phone. In other words, a mobile phone is unable to use a wireless method to control another mobile phone or execute a certain instruction.

In view of the foregoing shortcomings and the development trend of the present information technology, the inventor of the present invention conducted extensive researches and experiments, and finally developed a method of using short messages to send instructions to a mobile phone. Such ingenious idea of the invention is definitely a great contribution to the extensive consumers.

Since most of the common mobile phones in the market comes with the short message service function for sending or receiving short messages. Therefore, the primary objective of the present invention is to use the short message service method to send or receive a short message while attaching a control information or instruction, so that a mobile phone at a receiving end can execute the control information or instruction attached in the short message being received and be controlled by a device at a transmitting end.

The above and other objects, features and advantages of the present invention will become apparent from the following detailed description taken with the accompanying drawings.

### BRIEF DESCRIPTION OF THE DRAWINGS

FIG. 1 is an illustrative diagram of the present invention.

FIG. 2 is a flow chart of the present invention.

FIG. 3 is another flow chart of the present invention.

### DETAILED DESCRIPTION OF THE PREFERRED EMBODIMENTS

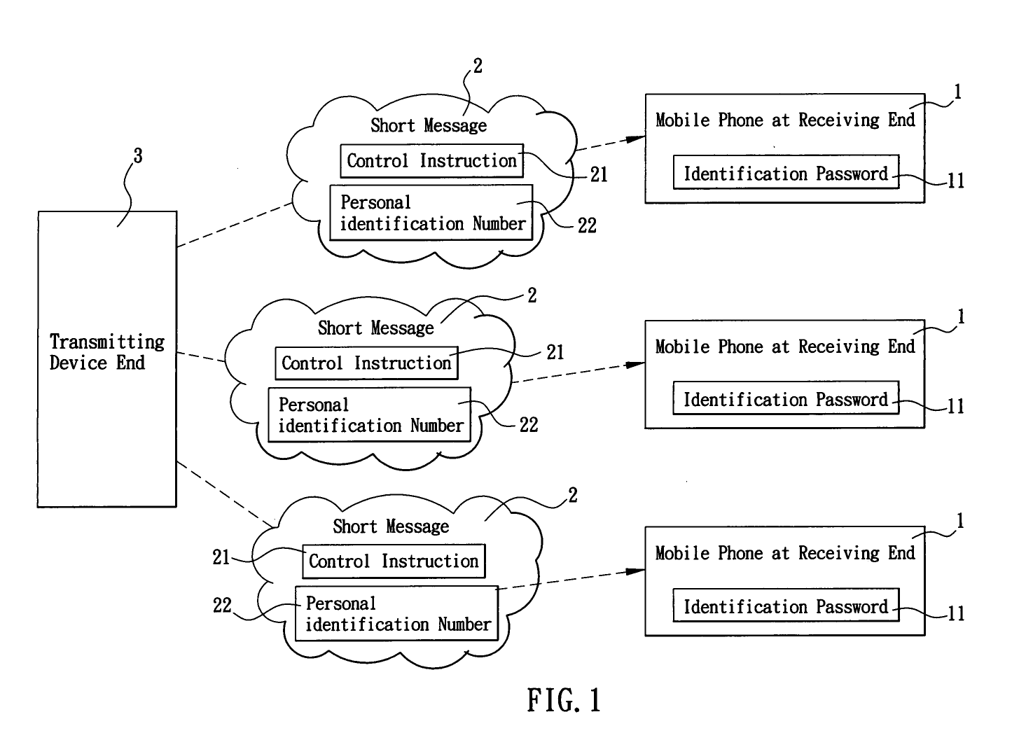

Please refer to FIG. 1 for the method of sending instructions through short messages, which presets a set of identification passwords 11 in all mobile phones 1 at the receiving end. Therefore, when a transmitting device 3 tries to send a certain amount of short message 2 having control information or instructions 21, the transmitting device 3 encodes each desired control instruction 21 respectively stipulated in different short message services (SMS) into at least one short message (or messages) 2, and sends a personal identification number 22 along with the short message 2 to each mobile phone 1 at the receiving end. After each mobile phone 1 at the receiving end has confirmed that the personal identification number 22 matches with the identification password 11, the mobile phone 1 can open the short message 2 and execute the related content of the control information or instruction 21.

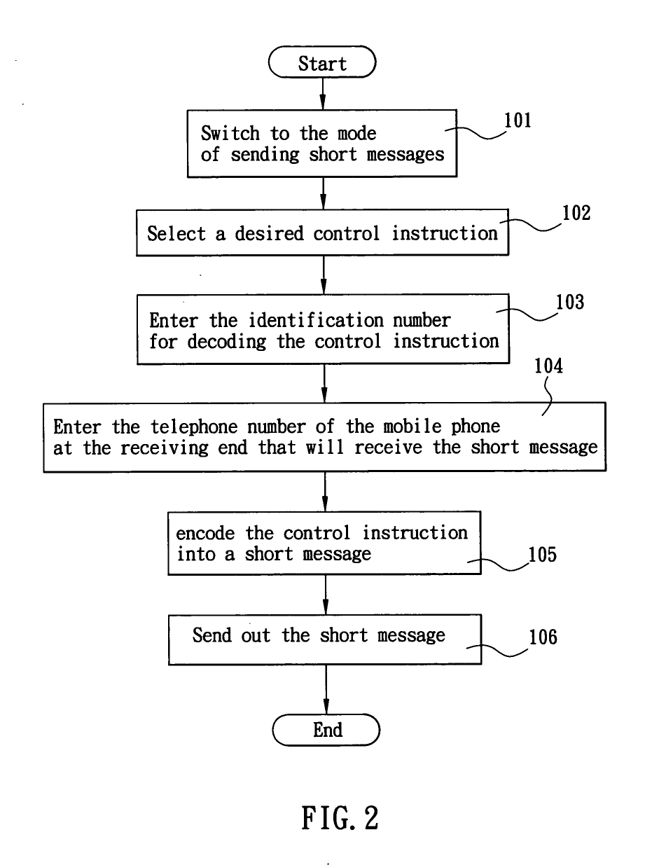

Please refer to FIG. 2 for the invention. When the transmitting device 3 end is going to send a short message with an instruction, the process comprises the steps of:
(101) switching to the mode of sending short messages 2;
(102) selecting a desired control instruction 21;
(103) entering the identification number 22 for decoding the control instruction 21;
(104) entering the telephone number of the mobile phone 1 at the receiving end that will receive the short message 2;
(105) encoding the control instruction 21 into a short message 2; and
(106) sending out the short message 2.

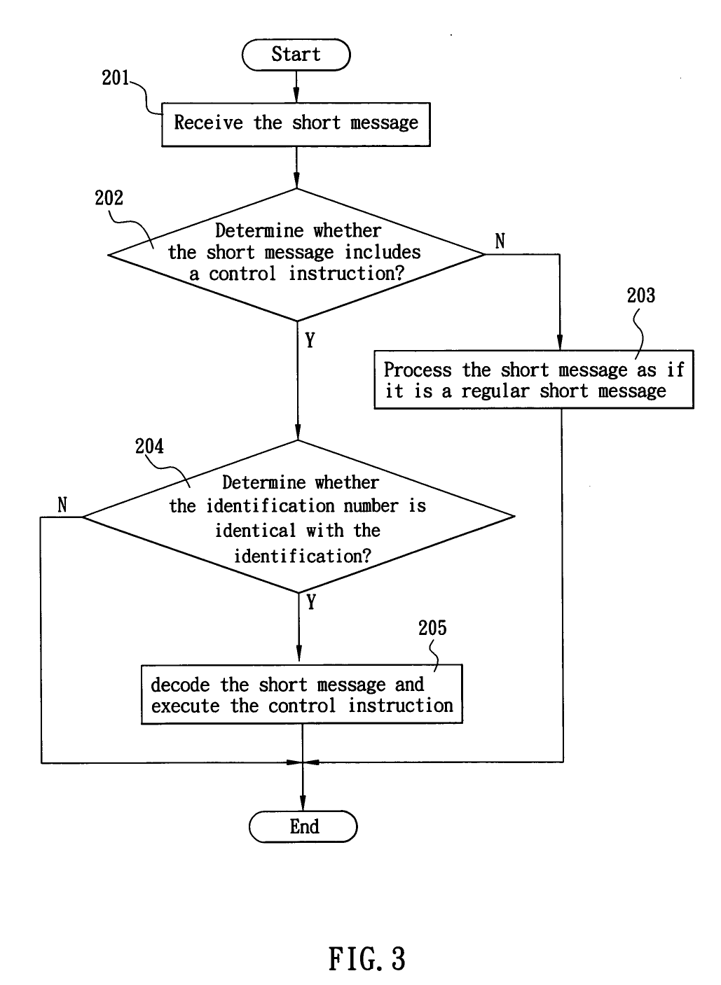

Please refer to FIG. 3 for the invention. When each mobile phone 1 at the receiving end receives a short message 2 having an instruction 21, the process comprises the steps of:
(201) receiving the short message 2;
(202) determining whether or not the short message 2 includes a control instruction 21;
if yes, go to Step (204); if no, go to Step (203);
(203) processing the short message 2 as if it is a regular short message;
(204) determining whether the identification number 22 being received is identical to the identification password 11 or not; if yes, go to Step (205) if no, end the process; and
(205) decoding the short message 2 and then executing the content of the control information or instruction 21 attached in the short message 2.

Please refer to FIG. 1 for the invention. The transmitting device end 3 could be a terminal such as a mobile phone, a personal digital assistant (PDA), a personal computer, or a smart phone.

While the invention has been described by means of specific embodiments, numerous modifications and variations could be made thereto by those skilled in the art without departing from the scope and spirit of the invention set forth in the claims.

What is claimed is:

1. A method for sending instruction to mobile phone by short message, comprising the steps of
presetting a plurality of identification passwords in mobile phones at a receiving end;
enabling a transmitting device to code a desired control instruction stipulated in different short message services into at least one short message, when said transmitting device end is going to send said short message including said control instruction, and to send a personal identification number along with said short message to said each mobile phone at said receiving end;
decoding said short message and executing the related content of said control instruction by said each mobile phone, after said each mobile phone at said receiving end has confirmed that said personal identification number matches with said identification password.

2. The method for sending instruction to mobile phone by short message of claim 1, wherein said transmitting device end sends out said short message including said instruction according to the steps of
switching to a mode of sending short messages;
selecting a desired control instruction;
entering said identification number for decoding said control instruction;
entering the telephone number of said mobile phone at said receiving end that receives said short message;
encoding said control instruction into said short message; and
sending out said short message.

3. The method for sending instruction to mobile phone by short message of claim 1, wherein said mobile phone at said receiving end sends out said message including said instruction according to the steps of:
receiving said short message;
determining whether said short message includes a control instruction;
determining whether the identification number being received is identical to the identification password or not, if said short message includes said control instruction; and
decoding said short message, if said identification number matches with said identification password.

4. The method for sending instruction to mobile phone by short message of claim 3, wherein said short message is processed according to a regular short message if said short message includes no control instruction.

5. The method for sending instruction to mobile phone by short message of claim 3, wherein said process ends if said identification number doesn't match with said identification password.

6. The method for sending instruction to mobile phone by short message of claim 3, wherein said transmitting device end is a terminal.

7. The method for sending instruction to mobile phone by short message of claim 6, wherein said terminal is a mobile phone.

8. The method for sending instruction to mobile phone by short message of claim 6, wherein said terminal is a personal digital assistant.

9. The method for sending instruction to mobile phone by short message of claim 6, wherein said terminal is a personal computer.

10. The method for sending instruction to mobile phone by short message of claim 6, wherein said terminal is a smart phone having a dual integrated function of a mobile phone and a personal digital assistant.
